(19) United States
(12) Patent Application Publication
(10) Pub. No.: US 2021/0373959 A1
(43) Pub. Date: Dec. 2, 2021

(54) TIME RELEASED DATA

(71) Applicant: HEWLETT-PACKARD DEVELOPMENT COMPANY, L.P., SPRING, TX (US)

(72) Inventor: ALEXANDER WAYNE CLARK, SPRING, TX (US)

(21) Appl. No.: 16/638,216

(22) PCT Filed: Nov. 7, 2017
(86) PCT No.: PCT/US2017/060375

§ 371 Date: Feb. 11, 2020

(51) Int. Cl. G06F 9/50; G06F 9/48; G06F 1/329; G06F 1/3287

(52) U.S. Cl. CPC G06F 9/5022; G06F 1/3287; G06F 1/329; G06F 9/4881

(57) ABSTRACT

Example implementations relate to time released data. For example, a system for time released data may comprise a processing resource and a memory resource storing readable instructions to cause the processing resource to store data to the memory resource when a sleep state instruction is determined, determine a release time for the data, and release the data during the sleep state at the release time for the data.

### BACKGROUND

Computing devices can include processors, memory resources, and user interfaces that can utilize electrical energy. In some examples, the computing devices can utilize a sleep state or hibernation state to utilize relatively less electrical energy compared to utilizing an on state or active state. In some examples, the sleep state can be activated when a designated time period occurs with little or no inputs for the computing device. In some examples, the sleep state can be activated to save battery power of the computing device.

### BRIEF DESCRIPTION OF THE DRAWINGS

FIG. 1 illustrates an example system for time released data, in accordance with the present disclosure.

FIG. 2 is a block diagram of an example controller for time released data, in accordance with the present disclosure.

FIG. 3 is a block diagram of an example computing device for time released data, in accordance with the present disclosure.

FIG. 4 is a block diagram of an example computing device for time released data, in accordance with the present disclosure.

### DETAILED DESCRIPTION

Examples described herein relate to time released data. For example, a system for time released data may comprise a processing resource and a memory resource storing readable instructions to cause the processing resource to store data to the memory resource when a sleep state instruction is determined, determine a release time for the data, and release the data during the sleep state at the release time for the data. In some examples, the systems, devices, and methods for time released data can be utilized to perform a number of functions during a sleep state of a computing device. For example, the examples described herein can be utilized to store calendar data to a memory resource when a sleep state is initiated. In this example, the calendar data can be utilized to generate reminders and/or notifications during the sleep state of the computing device without having to activate a main processing resource or memory resource.

As used herein, a sleep state or hibernation state of a computing device can include a power state that utilizes relatively less power than an on state or active state of the computing device. For example, the sleep state or hibernation state of the computing device can utilize less power than an on state by deactivating a central processing unit (CPU), a primary memory resource, a user interface, and/or a networking resource. In this example, the computing device can utilize the CPU, primary memory resource, user interface, and/or networking resource during an on state, but may not utilize the CPU, primary memory resource, user interface, or the networking resource during a sleep state or hibernation state to conserve electrical energy.

In some examples, the examples described herein can utilize a controller or a secondary processing resource, a secondary memory resource coupled to the controller, and/or a secondary display during the sleep state or hibernation state. For example, a controller can be utilized to determine when a sleep state for the computing device is initiated. In some examples, the controller can extract data from a primary memory resource when the sleep state is initiated and/or prior to the sleep state deactivating the primary memory resource. In addition, the controller can store the extracted data in a secondary memory resource and release or execute the data at a particular release time. In this way, the controller can perform a number of functions based on the extracted data during a sleep state without having to activate the CPU, primary memory resource, user interface, and/or networking resource.

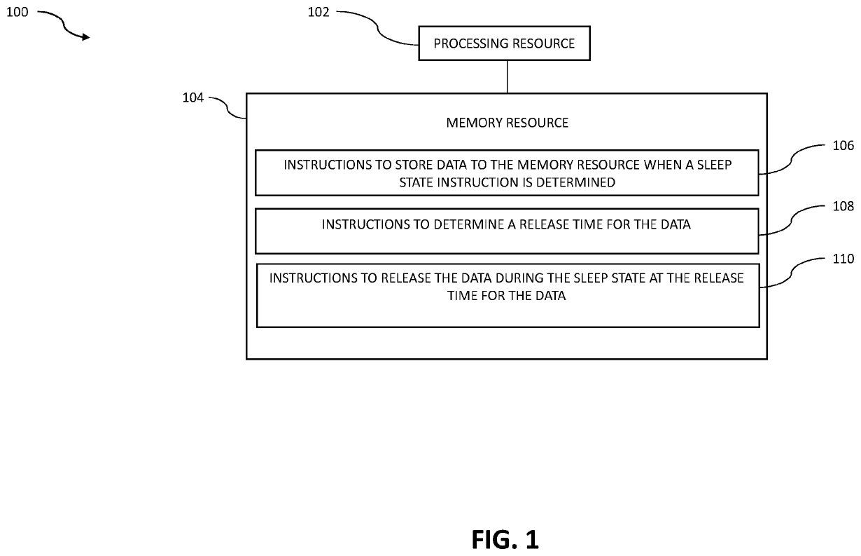

FIG. 1 illustrates an example system 100 for time released data, in accordance with the present disclosure. In some examples, the system 100 can be a computing device. For example, the system 100 can be a laptop computer or portable computing device. In some examples, the system 100 can include a memory resource 104 that can be utilized to store instructions 106, 108, 110 that can be executed by a processing resource 102 to perform functions described herein.

A processing resource 102 may be a central processing unit (CPU), microprocessor, and/or other hardware device suitable for retrieval and execution of instructions stored in memory resource 104. In the particular example shown in FIG. 1, processing resource 102 may receive, determine, and send instructions 106, 108, 110. As an alternative or in addition to retrieving and executing instructions 106, 108, 110, processing resource 102 may include an electronic circuit comprising a number of electronic components for performing the operations of the instructions 106, 108, 110 in the memory resource 102. With respect to the executable instruction representations or boxes described and shown herein, it should be understood that part or all of the executable instructions 106, 108, 110 and/or electronic circuits included within one box may be included in a different box shown in the figures or in a different box not shown.

Memory resource 104 may be any electronic, magnetic, optical, or other physical storage device that stores executable instructions 106, 108, 110. Thus, memory resource 104 may be, for example, Random Access Memory (RAM), an Electrically-Erasable Programmable Read-Only Memory (EEPROM), a storage drive, an optical disc, and the like. The executable instructions 106, 108, 110 may be stored on the memory resource 104. Memory resource 104 may be a portable, external or remote storage medium, for example, that allows a system to download the instructions 106, 108, 110 from the portable/external/remote storage medium. In this situation, the executable instructions 106, 108, 110 may be part of an “installation package”. As described herein, memory resource 104 may be encoded with executable instructions 106, 108, 110 for time release data. In some examples, the processing resource 102 can be a secondary processing resource for the system 100 and the memory resource 104 can be a secondary memory resource for the system 100.

The system 100 may include instructions 106 executable by a processing resource 102, to store data to the memory resource when a sleep state instruction is determined. In some examples, the sleep state instruction can include a notification that a sleep state has been initiated. In some examples, the initiation of a sleep state can include deactivating a number of devices associated with the computing device to save power. For example, an input can be received to initiate a sleep state of the computing device. In this example, it can take a quantity of time to complete the sleep state of the system 100. In this example, the system 100 can extract data from a primary memory resource during the quantity of time it takes the system 100 to complete the sleep state of the system 100.

In some examples, the system 100 can complete the sleep state when the system 100 has deactivated a processing resource, user interface, memory resource, and/or networking resource. In some examples, the system 100 can represent a processing resource 102 and a memory resource 104 that is separate from a primary processing resource and/or a primary memory resource of the system 100, For example, the primary processing resource and/or the primary memory resource can be deactivated during the sleep state and the processing resource 102 and/or the memory resource 104 can be active during the sleep state. For example, the processing resource 102 can be a controller (e.g., field programmable gate array (FPGA), multi-point control unit (MCU), etc.) that is separate from a central processing unit (CPU). In another example, the memory resource 104 can be a volatile or non-volatile memory resource that is separate from a primary memory resource.

In some examples, the system 100 can store the extracted data in the memory resource 104. In some examples, the data can include a notification (e.g., calendar reminder, alarm, note with a time to be displayed, etc.) to be displayed at the release time. For example, the system 100 can extract calendar information from a primary memory resource and/or a calendar application (e.g., Microsoft Outlook®, etc.). In this example, the extracted calendar information can include a number of reminder notifications for calendar events that can be displayed on a user interface to notify a user of the calendar events. In these examples, a time when the notification is to be displayed on the user interface can be determined and utilized as a release time for the corresponding data. As used herein, the release time for the corresponding data can be a time that the data is released from the memory resource 104 during the sleep state of the system 100.

The system 100 may include instructions 108 executable by a processing resource 102, to determine a release time for the data. As described herein, the release time for the data can be a point in time when the data is to be released from the memory resource 104 during the sleep state of the system 100. For example, the release time of a notification that a meeting will begin at 10:00 AM central standard time (CST) can have a release time of 10:00 AM CST. In this example, the release time can also correspond to a time that is earlier than the start time of the meeting (e.g., 9:45 AM CST, etc.).

In some examples, the release time for the data can be determined by extracting information relating to the data. For example, the instructions 108 can include instructions that can be executable by the processing resource 102 to extract date and time information relating to the data. In some examples, extracting the date and time information relating to the data can include the date and time information utilized to provide a notification relating to the data during a non-sleep state. For example, the data can include metadata to indicate a time to provide the notification relating to the data. In this example, the metadata can be extracted from the data to determine the release time for the data.

The system 100 may include instructions 110 executable by a processing resource 102, to release the data during the sleep state at the release time for the data. In some examples, releasing the data during the sleep state can include extracting the data from the memory resource 104 to be executed by the system 100. As described herein, the system 100 can be a controller or subsystem of a computing device that can be activated or continue to be activated during the sleep state of the computing device. Thus, the system 100 can be utilized to release data during the sleep state to execute instructions corresponding to the released data at the release time during the sleep state of the computing device.

The system 100 can release the data stored in the memory resource 104 at the release time to the processing resource 102 during the sleep state. In some examples, the released data can include corresponding instructions that can be executed by the processing resource 102 during the sleep state. For example, the data can be stored in the memory resource 104 when it is determined that the computing device is going to be put into a sleep state. In this example, the data can be extracted from a memory resource and stored in the memory resource 104 to be released at a particular time during the sleep state and executed by the processing resource 102 during the sleep state.

In some examples, the system 100 can include an internal clock that can be utilized to determine when the release time has occurred. For example, the internal clock can provide a date and time to the system 100, which can be utilized to determine when the release time is occurring and/or when to execute instructions that correspond to the data. In this way, the system 100 may not utilize the CPU, primary memory resource, and/or networking resource of the computing device during the sleep state, Thus, the electrical energy utilized by the computing device during the sleep state can remain low since the CPU, primary memory resource, or networking resource can remain deactivated during the sleep state while the system 100 stores and executes the data stored prior to the activation of the sleep state. In some examples, the released data during the sleep state can be executed by a secondary processing resource (e.g., processing resource 104, microcontroller, FPGA, etc.) and displayed on a secondary display (e.g., notification panel separate from a primary display, display not utilized during an on state or active state, etc.).

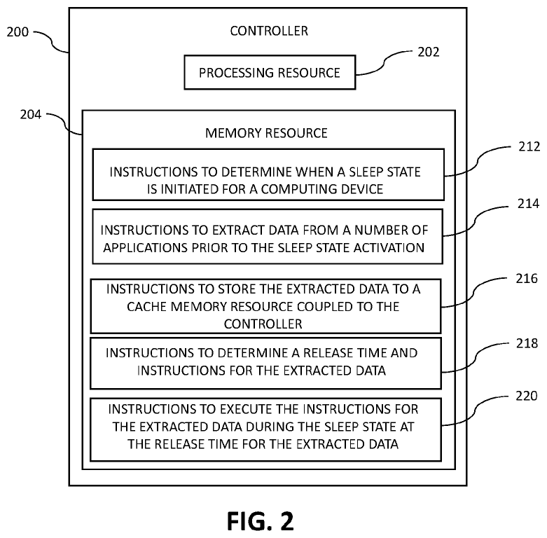

FIG. 2 is a block diagram of an example controller 200 for time released data, in accordance with the present disclosure. In some examples, the controller 200 can part of a laptop computer or portable computing device as referenced in FIG. 1. In some examples, the controller 200 can include a memory resource 204 that can be utilized to store instructions 212, 214, 216, 218, 220 that can be executed by a processing resource 202 to perform functions described herein.

A processing resource 202 may be a central processing unit (CPU), microprocessor, and/or other hardware device suitable for retrieval and execution of instructions stored in memory resource 204. In the particular example shown in FIG. 2, processing resource 202 may receive, determine, and send instructions 212, 214, 216, 218, 220. As an alternative or in addition to retrieving and executing instructions 212, 214, 216, 218, 220, processing resource 202 may include an electronic circuit comprising a number of electronic components for performing the operations of the instructions 212, 214, 216, 218, 220 in the memory resource 204. With respect to the executable instruction representations or boxes described and shown herein, it should be understood that part or all of the executable instructions 212, 214, 216, 218, 220 and/or electronic circuits included within one box may be included in a different box shown in the figures or in a different box not shown.

Memory resource 204 may be any electronic, magnetic, optical, or other physical storage device that stores executable instructions 212, 214, 216, 218, 220. Thus, memory resource 204 may be, for example, Random Access Memory (RAM), an Electrically-Erasable Programmable Read-Only Memory (EEPROM), a storage drive, an optical disc, and the like. The executable instructions 212, 214, 216, 218, 220 may be stored on the memory resource 204. Memory resource 204 may be a portable, external or remote storage medium, for example, that allows a system to download the instructions 212, 214, 216, 218, 220 from the portable/external/remote storage medium. In this situation, the executable instructions 212, 214, 216, 218, 220 may be part of an “installation package”. As described herein, memory resource 204 may be encoded with executable instructions 212, 214, 216, 218, 220 for time released data.

The controller 200 may include instructions 212 executable by a processing resource 202, to determine when a sleep state is initiated for a computing device. In some examples, determining when a sleep state is initiated can include receiving an instruction that a sleep state has been initiated for a computing device. The instruction can be received by the controller 200 to notify the controller 200 that a sleep state process for activating a sleep state has been initiated. For example, a selection can be made to initiate a sleep state for the computing device. In this example, the selection can provide instructions to components of the computing device to alter from an on state to a sleep state. In this example, the instructions can be utilized to deactivate particular components, activate particular components, and/or alter a power setting of particular components.

In some examples, a sleep state selection can include instructions to deactivate a primary display, a primary processing resource, a primary memory resource, and/or a networking resource (e.g., wireless or wired network card, network ports, etc.). In some examples, the controller 200 can include a processing resource 202 that is a secondary processing resource (e.g., microcontroller, FPGA, etc.) and a memory resource 204 that is a secondary memory resource (e.g., non-volatile memory resource, etc.) that can remain operational during the sleep state of the computing device. In some examples, the controller 200 can be coupled to a secondary display that is separate from a primary display. In some examples, the primary display can be utilized during an on state or active state of the computing device while the secondary display can be utilized during a sleep state, off state, and/or an on state of the computing device. For example, the secondary display can be utilized to display notifications or receive notes during a sleep state or off state of the computing device.

The controller 200 may include instructions 214 executable by a processing resource 202, to extract data from a number of applications prior to the sleep state activation. In some examples, the controller 200 can, in response to determining that the sleep state is initiated, extract relevant data from a primary memory resource and/or from the number of applications prior to the sleep state being activated. For example, instructions can be received to put the computing device in a sleep state. In this example, the controller 200 can extract the data from the number of applications before the sleep state has been completed or before the memory resource and/or applications have been deactivated. In this example, the relevant data can be notifications for a particular time period (e.g., one day, one week, one month, etc.).

In some examples, the particular time period can be adjusted based on a particular state of the computing device or a particular state that the computing device is activating. For example, the particular time period can be one day when the computing device is activating a sleep state and the particular time period can be one week when the computing device is activating a hibernation state. In this example, the controller 200 can extract data that is relevant to the next 24 hours when the computing device is activating a sleep state and extract data that is relevant to the next week when the computing device is activating the hibernation state. In some examples, the relevant data for a time period can include data that has a release time that is within the particular time period. For example, the data can include a notification to be displayed at Jan. 1, 2020 at 10:00 AM CST. In this example, the data can be relevant when the particular time period includes Jan. 1, 2020, but may not be relevant when the particular time period does not include Jan. 1, 2020.

In some examples, the particular time period can be altered for each state of the computing device and/or based on a selection that is prompted when selecting a sleep state for the computing device. For example, a selection can be made to activate a sleep state for the computing device. In this example, a prompt to select a time period can be displayed and a selection of a particular time period can be made to indicate the particular time period for extracting data. In some examples, the particular time period can be selected based on an expected duration of the sleep state.

The controller 200 may include instructions 216 executable by a processing resource 202, to store the extracted data to a cache memory resource (e.g., memory resource 204, random access memory resource, etc) coupled to the controller 200. In some examples, the controller 200 can be coupled to the memory resource 204 when the memory resource 204 is separate and distinct from a primary memory resource for a computing device. For example, the memory resource 204 can be in an active state while the primary resource is in a deactivated state to conserve power during a sleep state.

In some examples, the controller 200 can store the extracted data to the memory resource 204 during the activation of the sleep state of the computing device. For example, the initiation of the sleep state can include a period of time for deactivating a plurality of components as described herein. In this example, the period of time can be utilized to extract the data and store the data to the memory resource 204. In this example, the stored data can be released during the sleep state such that other components of the computing device are not activated during the sleep state to extract data and/or execute instructions corresponding to the extracted data.

The controller 200 may include instructions 218 executable by a processing resource 202, to determine a release time and instructions for the extracted data. As described herein, the data can include a corresponding release time and instructions to be executed at the release time. In some examples, determining the release time can include extracting the release time from the data. For example, the data can include metadata that includes the release time for the data. In this example, the controller 200 can include an internal clock to determine when the release time occurs.

The controller 200 may include instructions 220 executable by a processing resource 202, to execute the instructions for the extracted data during the sleep state at the release time for the extracted data. In some examples, executing the instructions for the extracted data can include generating and/or displaying a notification for the extracted data at the release time during the sleep state. In some examples, the notification can be displayed on a secondary display that is separate from a primary display. For example, a computing device can include a primary display that can be utilized during an active state and a secondary display that can be utilized during the sleep state.

In some examples, the instructions for the extracted data can be executed without real time updates during the sleep state. For example, the instructions for the extracted data can be executed without updates from a primary memory resource and/or a network connection. In this example, the instructions for the extracted data can be executed without having to activate or reactivate a component during the sleep state.

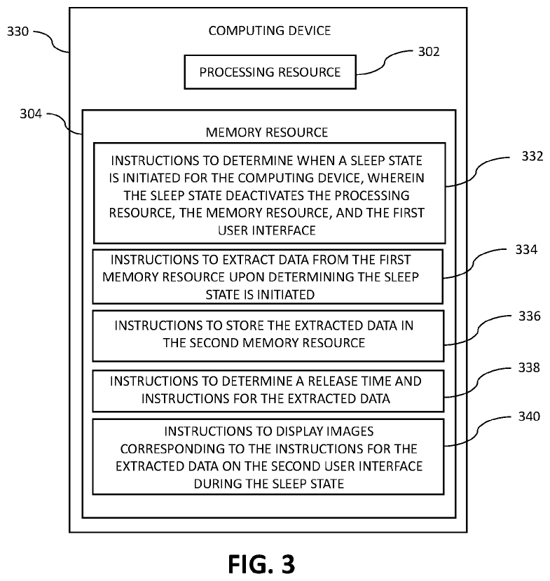

FIG. 3 is a block diagram of an example computing device 330 for time released data, in accordance with the present disclosure. In some examples, the computing device 330 can be a laptop computer or portable computing device. In some examples, the computing device 330 can include a memory resource 304 that can be utilized to store instructions 332, 334, 336, 338, 340 that can be executed by a processing resource 302 to perform functions described herein.

A processing resource 302 may be a central processing unit (CPU), microprocessor, and/or other hardware device suitable for retrieval and execution of instructions stored in memory resource 304. In the particular example shown in FIG. 3, processing resource 302 may receive, determine, and send instructions 332, 334, 336, 338, 340. As an alternative or in addition to retrieving and executing instructions 332, 334, 336, 338, 340, processing resource 302 may include an electronic circuit comprising a number of electronic components for performing the operations of the instructions 332, 334, 336, 338, 340 in the memory resource 304. With respect to the executable instruction representations or boxes described and shown herein, it should be understood that part or all of the executable instructions 332, 334, 336, 338, 340 and/or electronic circuits included within one box may be included in a different box shown in the figures or in a different box not shown.

Memory resource 304 may be any electronic, magnetic, optical, or other physical storage device that stores executable instructions 332, 334, 336, 338, 340. Thus, memory resource 304 may be, for example, Random Access Memory (RAM), an Electrically-Erasable Programmable Read-Only Memory (EEPROM), a storage drive, an optical disc, and the like. The executable instructions 332, 334, 336, 338, 340 may be stored on the memory resource 304. Memory resource 304 may be a portable, external or remote storage medium, for example, that allows a system to download the instructions 332, 334, 336, 338, 340 from the portable/external/remote storage medium. In this situation, the executable instructions 332, 334, 336, 338, 340 may be part of an “installation package”. As described herein, memory resource 304 may be encoded with executable instructions 332, 334, 336, 338, 340 for time released data.

In some examples, the computing device 330 can include a processing resource and a controller. In some examples, the controller can include a processing resource 302 coupled to a memory resource 304 that is separate from a primary processing resource such as a CPU. In some examples, the computing device 330 can include a first display (e.g., primary display) and a second display (e.g., secondary display).

The computing device 330 may include instructions 332 executable by a processing resource 302, to determine when a sleep state is initiated for the computing device 330, wherein the sleep state deactivates the processing resource, the memory resource, and the first user interface. As described herein, the sleep state can be initiated by a selection and the computing device 330 can deactivate a plurality of components such as the primary processing resource, the primary memory resource, and/or a first user interface that is utilized as a primary user interface.

The computing device 330 may include instructions 334 executable by a processing resource 302, to extract data from the first memory resource upon determining the sleep state is initiated. In some examples, that data can be extracted from the first memory resource prior to deactivation of the processing resource, the memory resource, and the first user interface. As described herein, the first memory resource can be a primary memory resource utilized to store a plurality of applications and/or operating system of the computing device 330. In some examples, the computing device 330 can extract data from the primary memory resource and/or applications stored on the primary memory resource. As described herein, the extracted data can include data relating to notifications, calendar events, alarms, and/or other notes to be displayed or executed at a particular time (e.g., release time). For example, the instructions 334 can include instructions to display a notification that corresponds to the extracted data on the second user interface at the release time.

The computing device 330 may include instructions 336 executable by a processing resource 302, to store the extracted data in the second memory resource (e.g., memory resource 304, etc.). In some examples, the processing resource 302 can be coupled to the primary memory resource and/or the second memory resource such that data extracted from the primary memory resource can be stored in the second memory resource prior to the primary memory resource being deactivated by the sleep state instructions.

The computing device 330 may include instructions 338 executable by a processing resource 302, to determine a release time and instructions for the extracted data. As described herein, the release time and instructions can be determined or extracted from metadata corresponding to the extracted data. In some examples, the release time can be determined based on a time of execution for the extracted data. For example, the release time can correspond to a time that the computing device 330 would execute the instructions or display a notification for the extracted data during a non-sleep state or active state.

The computing device 330 may include instructions 340 executable by a processing resource 302, to display images corresponding to the instructions for the extracted data on the second user interface during the sleep state. As described herein, the extracted data can be a notification or calendar reminder that can be displayed on the second user interface instead of the first user interface during the sleep state. In this way, notifications or other types of reminders can be displayed on the second user interface without activating the first user interface, which can be deactivated during the sleep state.

In some examples, the computing device 330 can include instructions executable by the processing resource 302 to receive an input via the second user interface during the sleep state. As described herein, the second user interface can be a secondary user interface that is active during the sleep state. In these examples, the second user interface can receive a number of inputs. For example, the second user interface can be a touch screen or include a number of physical buttons that can be utilized to provide inputs via the second user interface during the sleep state. In this example, an input can be provided to the second user interface during the sleep state and executed or stored in the first memory resource when the on state is activated.

In some examples, the input can be a note, calendar meeting, and/or other type of input. In these examples, the input can be stored in the second memory resource (e.g., memory resource 304, etc.) during the sleep state. In these examples, the input can be executed or stored in the first memory resource when the on state is activated. For example, the input can be a new calendar meeting for a calendar application (e.g., Microsoft Outlook®, etc.). In this example, the calendar meeting can be utilized to update the calendar application when the on state is activated.

In some examples, the computing device 330 can execute the input received via the second user interface when the sleep state is deactivated and an on state is activated. For example, the calendar meeting can be extracted from the second memory resource and stored in the first memory resource or stored with the calendar application to update the calendar with the calendar meeting. In this way, the first memory resource or the application can remain deactivated during the sleep state and continue to be updated during the sleep state via the second user interface and second memory resource.

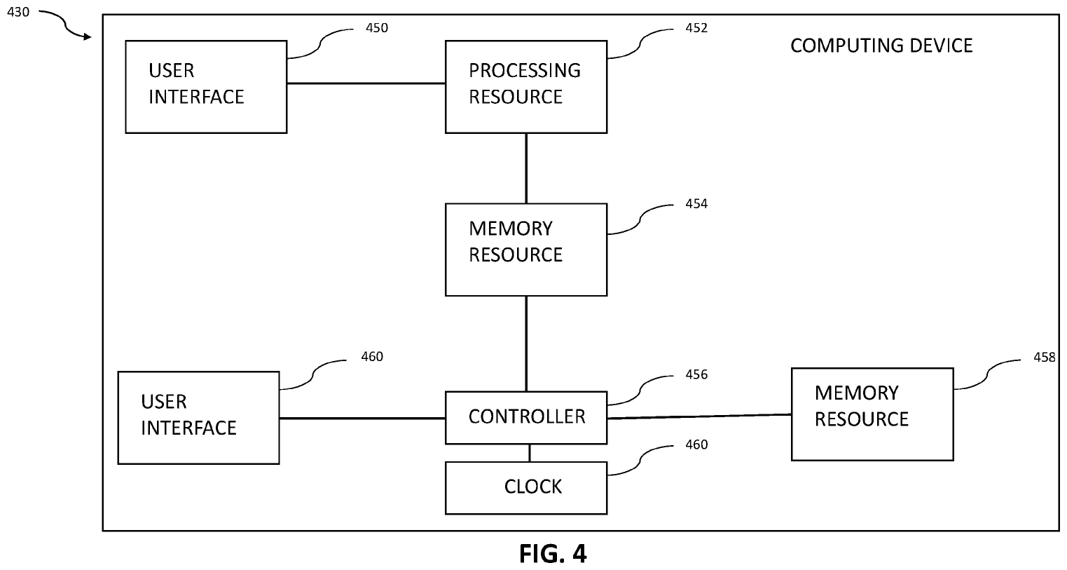

FIG. 4 is a block diagram of an example computing device 430 for time released data, in accordance with the present disclosure. The computing device 430 can be utilized to execute or perform the functions described herein. For example, the functions describe in relation to FIG. 1, FIG. 2, and/or FIG. 3 can be executed by the controller 456. In some examples, the computing device 430 can include a laptop computing device that includes a primary user interface 450 (e.g., primary display, etc.), a primary processing resource 452 (e.g., CPU, etc.), and/or a primary memory resource 454 (e.g., main memory resource, etc.) that can be utilized during an on state or active state.

In some examples, the primary memory resource 454 can be coupled to a controller 456. As described herein, the controller 456 can be a microcontroller or a FPGA processing resource. The controller 456 can be coupled to the memory resource 454 for extracting data prior to the activation of a sleep state of the computing device 430. For example, the controller 456 can be utilized to determine that a sleep state is initiated. In this example, the controller 456 can extract data from the primary memory resource 454 before the primary memory resource 454, primary processing resource 452, and/or the primary user interface 450 is deactivated by the sleep state of the computing device 430. As described herein, the data that is extracted from the memory resource 454 can be time sensitive data such as calendar notifications, alarm notifications, or other types of notifications that may occur during the sleep state of the computing device 430.

As described herein, the controller 456 can be coupled to a secondary memory resource 458. In some examples, the controller 456 can store the extracted data from the primary memory resource 454 at the secondary memory resource 458. In some examples, the secondary memory resource 458 may be active during the sleep state and/or not utilize electrical energy to remain operational. In some examples, the secondary memory resource 458 can be a cache memory resource that is coupled to the controller 456. As described herein, the controller 456 can be utilized to determine a release time for the extracted data. As described herein, the release time can be a date and time when the extracted data is to be released, executed, or displayed.

In some examples, the controller 456 can be coupled to an internal clock 460. The internal clock 460 can be a device to notify the controller 456 of a date and time. As described herein, the internal clock 460 can be utilized by the controller 456 to determine when the extracted data is to be released. For example, the controller 456 can utilize the internal clock 460 to determine when a notification is to be displayed or when an alarm is to be executed by the controller 456 during the sleep state of the computing device 430.

In some examples, the controller 456 can be coupled to a secondary user interface 460. In some examples, the secondary user interface 460 can be separate from the primary user interface 450. For example, the computing device 430 can be a laptop computing device that includes a primary user interface 450 positioned on a first side of an enclosure that can align with a keyboard. In this example, the secondary user interface 460 can be positioned on a second side of the enclosure. In this example, the primary user interface 450 can be utilized when the laptop computing device is in an open position and the secondary user interface 460 can be displayed when the laptop computing device is in a closed position. In this way, the secondary user interface 460 can be utilized while the computing device 430 is in a closed position and/or when the computing device 430 is in a sleep state as described herein.

In some examples, the controller 456 can be utilized to display images or notifications on the secondary user interface 460 during the sleep state of the computing device 430. For example, the controller 456 can determine a release time for a plurality of extracted data stored in the secondary memory resource 458. In this example, the controller 456 utilize the internal clock 460 to determine when the release time for the plurality of extracted data occurs. When the release time occurs according to the internal clock 460, the controller 456 can execute corresponding instructions of the extracted data. For example, the controller 456 can execute instructions to display a notification or other data relating to the extracted data when the release time occurs according to the internal clock 460.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designator “N”, particularly with respect to reference numerals in the drawings, indicates that a number of the particular feature so designated can be included with examples of the present disclosure. The designators can represent the same or different numbers of the particular features. Further, as used herein. “a number of” an element and/or feature can refer to one or more of such elements and/or features.

What is claimed:

1. A system, comprising:
a processing resource; and
a memory resource storing readable instructions to cause the processing resource to:
store data to the memory resource when a sleep state instruction is determined;
determine a release time for the data; and
release the data during the sleep state at the release time for the data.

2. The system of claim 1, wherein the processing resource is a secondary processing resource for the system and the memory resource is a secondary memory resource.

3. The system of claim 2, wherein a primary processing resource for the system and a primary memory resource for the system are deactivated during the sleep state.

4. The system of claim 1, wherein the data includes a notification to be displayed at the release time.

5. The system of claim 1, wherein the sleep state deactivates a central processing unit (CPU), a network card, and a primary display of the system.

6. The system of claim 1, wherein the release time for the data is extracted from the data.

7. The system of claim 1, wherein the released data during the sleep state is executed by a secondary processing resource and displayed on a secondary display.

8. A controller, comprising instructions to:
determine when a sleep state is initiated for a computing device;
extract data from a number of applications prior to the sleep state activation;
store the extracted data to a cache memory resource coupled to the controller;
determine a release time and instructions for the extracted data; and
execute the instructions for the extracted data during the sleep state at the release time for the extracted data.

9. The controller of claim 8, wherein the controller is one of a field programmable gate array (FPGA) and a multi-point control unit (MCU).

10. The controller of claim 8, wherein the instructions for the extracted data are executed without real time updates during the sleep state.

11. A computing device, comprising:
a processing resource coupled to a first memory resource;
a first user interface and a second user interface;
a controller coupled to a second memory resource comprising instructions executable by the controller to:
determine when a sleep state is initiated for the computing device, wherein the sleep state deactivates the processing resource, the memory resource, and the first user interface;
extract data from the first memory resource upon determining the sleep state is initiated;
store the extracted data in the second memory resource;
determine a release time and instructions for the extracted data; and
display images corresponding to the instructions for the extracted data on the second user interface during the sleep state.

12. The computing device of claim 11, comprising instructions executable by the controller to receive an input via the second user interface during the sleep state.

13. The computing device of claim 12, comprising instructions executable by the controller to execute the input received via the second user interface when the sleep state is deactivated and an on state is activated.

14. The computing device of claim 11, wherein the instructions to display images corresponding to the instructions for the extracted data includes instructions to display a notification that corresponds to the extracted data on the second user interface at the release time.

15. The computing device of claim 11, wherein the data is extracted from the first memory resource prior to deactivation of the processing resource, the memory resource, and the first user interface.
